(19) United States
(12) Patent Application Publication
(10) Pub. No.: US 2007/0216219 A1
(43) Pub. Date: Sep. 20, 2007

(54) Truck trailer door-activated air brake release lock system for use with spring-set air-release trailer brakes

(76) Inventors: William D. Rice, Red Bluff, CA (US); Glenn Hughes, Anderson, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/378,757

(22) Filed: Mar. 17, 2006

(51) Int. Cl. B60T 15/02

(52) U.S. Cl. 303/68

(57) ABSTRACT

A truck trailer door-activated air brake release lock system for use with spring-set air-release vehicle brakes. The system includes a two-position two-port spool valve having a first port configured for fluid communication with a supply of pressurized air, a second port configured for fluid communication with the air release inlet port for a truck trailer brake; a spring-biased spool located within the body of the two-position two-port spool valve, the spool being configured to travel between a first position and a second position, wherein in the first position, the spool valve is in an open position allowing the first port and the second port to be in fluid communication, and wherein in the second position, the spool valve is in a closed position preventing a fluid communication between the first port and the second port; and a plunger configured for being coupled with a truck trailer door, the plunger dimensioned for engaging the spool, such that when the truck trailer door is closed, the plunger is in contact with the spool valve and causes the spool valve to be in the first position, and when the truck trailer door is not fully closed, the spool valve is in the second position.

### BACKGROUND OF THE INVENTION

The present invention relates in general to braking systems for vehicles, such as truck trailers. More particularly, the present invention relates to a truck trailer door-activated air brake release lock system for use with spring-set air-release trailer brakes.

Trailer trucks typically utilize a spring-set air-release trailer brake system, also referred to as air parking brakes. Air parking brakes utilize an air-controlled spring system that cooperates with the brake shoes of a vehicle's back wheels. Air parking brake systems exist in commonly-used commercial vehicles, such as trucks, commercial buses, or school buses. The air parking brake system has an air source, the spring mechanism, and an air control valve called an “air loading valve” between the air source and the spring mechanism. The air loading valve is controlled only by a manual handle, which is in the vehicle cab on the dashboard or in other positions accessible to the operator. The loading valve manual handle works in a “Pull To Apply” and “Push To Release” manner. Pulling the handle closes the air loading valve, whereby air pressure from the air source is blocked and downstream air pressure is vented so that the springs move to a position that applies the brake. Pushing the handle opens the air loading valve and closes the vent, whereby air is supplied to the spring mechanism so that the springs move to a position that releases the brake.

Many industrial accidents have occurred and continue to occur when a truck trailer's door is left open without the knowledge of the loading crews or the driver. With a loaded truck, and with its roll-type door open, as the trailer moves, accidents can happen, as items fall off the back of the trailer, whose door has been left open. While many have attempted to address this issue by using various work safety procedures, the fact that such accidents continue to occur is a testament that there exists a need for a more robust and simple safety system to prevent the occurrence of such accidents.

### BRIEF SUMMARY OF THE INVENTION

The present invention provides a door stop safety valve. The valve when installed in a truck brake system is placed at the rear of the trailer under the rear door rail. The novel valve is a normally closed valve, and its functionality is elegantly simple. The air lines that normally come from the front of the trailer to the service/release valve are interrupted and routed to the novel door stop safety valve. When the trailer door is opened the door stop safety valve is configured to stop air flow to the service/release valve, allowing brakes to stay locked and therefore preventing the trailer from any movement. When the trailer door is closed, the valve is configured to open thus allowing air to flow and thus release the brakes so that the trailer can move. In rather simple terms, when the trailer door is up, the trailer is not movable, and when the trailer door is down, the trailer is movable.

In one embodiment, the present invention provides a truck trailer door-activated air brake release lock system for use with spring-set air-release vehicle brakes. The system includes a two-position two-port spool valve having a first port configured for fluid communication with a supply of pressurized air, a second port configured for fluid communication with the air release inlet port for a truck trailer brake; a spring-biased spool located within the body of the two-position two-port spool valve, the spool being configured to travel between a first position and a second position, wherein in the first position, the spool valve is in an open position allowing the first port and the second port to be in fluid communication, and wherein in the second position, the spool valve is in a closed position preventing a fluid communication between the first port and the second port; and a plunger configured for being coupled with a truck trailer door, the plunger dimensioned for engaging the spool, such that when the truck trailer door is closed, the plunger is in contact with and causes the spool valve to be in the first position, and when the truck trailer door is not fully closed, the spool valve is in the second position.

For a further understanding of the nature and advantages of the invention, reference should be made to the following description taken in conjunction with the accompanying drawings.

### BRIEF DESCRIPTION OF THE DRAWINGS

FIG. 1 is an exemplary schematic drawing of a conventional truck and trailer brake system.

FIG. 2 is an exemplary schematic drawing showing the brake system of FIG. 1 retrofitted with the door stop safety valve in accordance with the embodiments of the present invention, with the trailer door down or closed.

FIG. 3 is an exemplary schematic drawing showing the brake system of FIG. 1 retrofitted with the door stop safety valve in accordance with the embodiments of the present invention, with the trailer door open.

FIG. 4 is an exemplary diagram showing the back of trailer which has been retrofitted with the door stop safety valve in accordance with the embodiments of the present invention, with the trailer door down or closed.

FIG. 5 is an exemplary diagram showing the back of trailer which has been retrofitted with the door stop safety valve in accordance with the embodiments of the present invention, with the trailer door up or open.

FIG. 6 is a simplified cross-sectional view through the door stop safety valve in accordance with the embodiments of the present invention, with the trailer door down or closed.

FIG. 7 is a simplified cross-sectional view through the door stop safety valve in accordance with the embodiments of the present invention, with the trailer open.

### DETAILED DESCRIPTION OF THE INVENTION

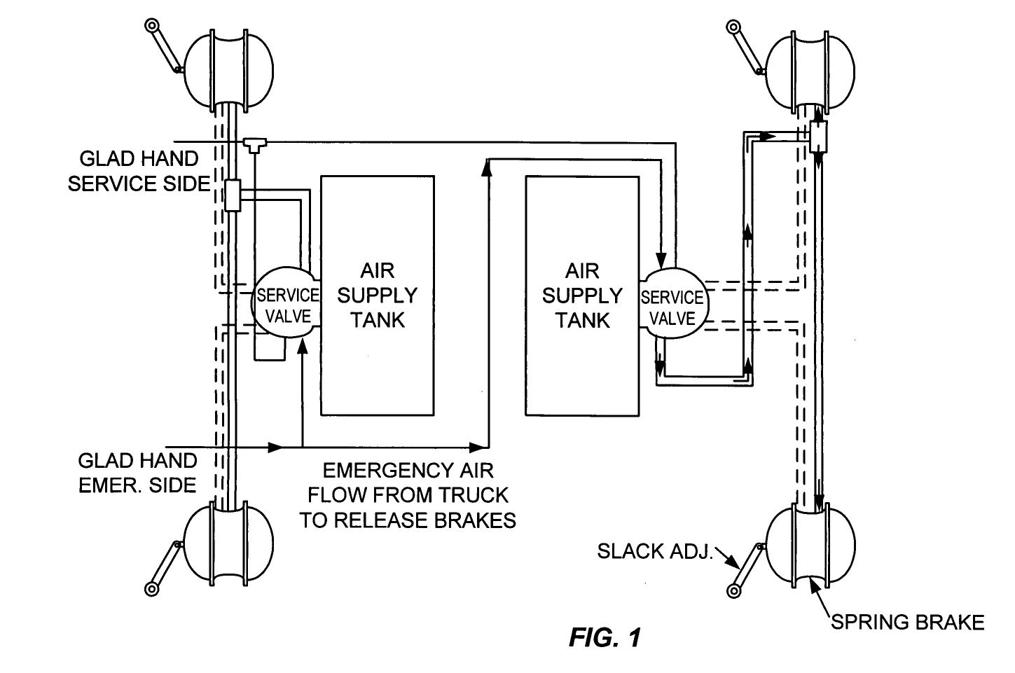

FIG. 1 shows an exemplary schematic drawing of a conventional truck and trailer brake system. As is shown in FIG. 1, during normal operation, air flows from the truck side (not shown) to the trailer, and the emergency air flow from the truck side goes through a service valve and releases the spring-set brakes. Shown in FIG. 1 is a typical arrangement where two compressed air tanks that supply compressed air to four spring-set air-release brakes where air flow to each set of two brakes is controlled by a service valve. Such a system is well-known to those of ordinary skill in truck trailer operation and maintenance and design.

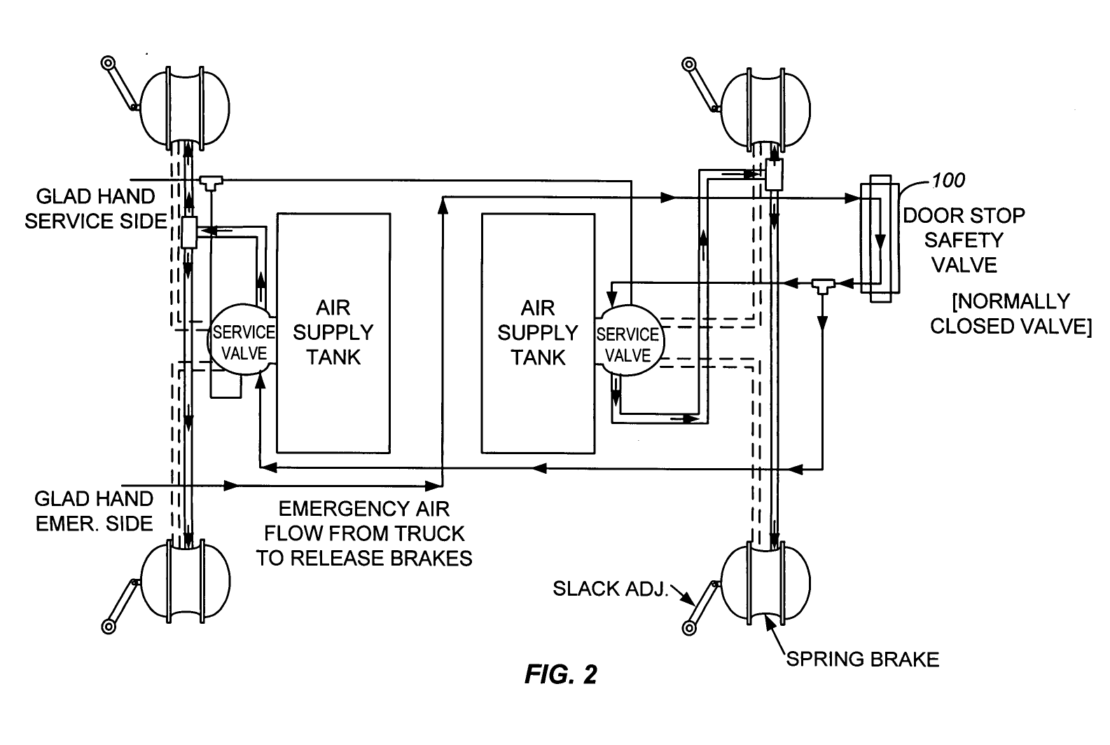

FIG. 2 shows an exemplary schematic drawing showing the brake system of FIG. 1 retrofitted with the door stop safety valve in accordance with the embodiments of the present invention, with the trailer door down or closed. As can be seen in FIG. 2, the brake system has been retrofitted by having the compressed air flow lines that feed each of the service valves interrupted by the door stop safety valve 100. So, instead of compressed air from the supply feeding each service valve, the flow must first pass through the door stop safety valve 100. And as shown in FIG. 2, when the normally closed valve is in its open position, the brake system operation is as it was in the non-retrofitted system. In other words, when the trailer door is down or closed, the door stop safety valve is configured to be in its open position, allowing air to travel in its normal route to release the trailer brakes.

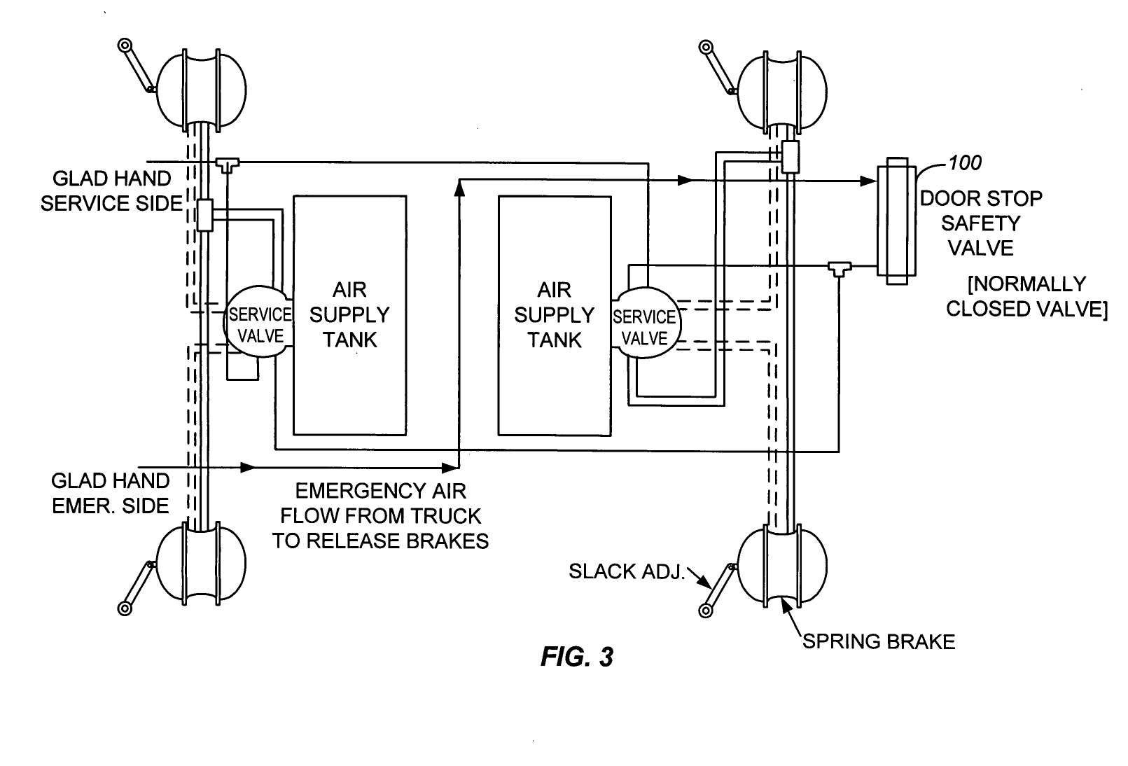

On the other hand, as shown in FIG. 3, when the normally closed door stop safety valve is in its closed position, the retrofitted system is configured such that air flow to the service/release valve(s) is blocked and the trailer will not be able to move. In other words, when the trailer door is open or not fully closed, the door stop safety valve is configured to be in its normally closed position, blocking airflow to the service/release valve, causing the trailer to be blocked from movement when its trailer door is not fully closed.

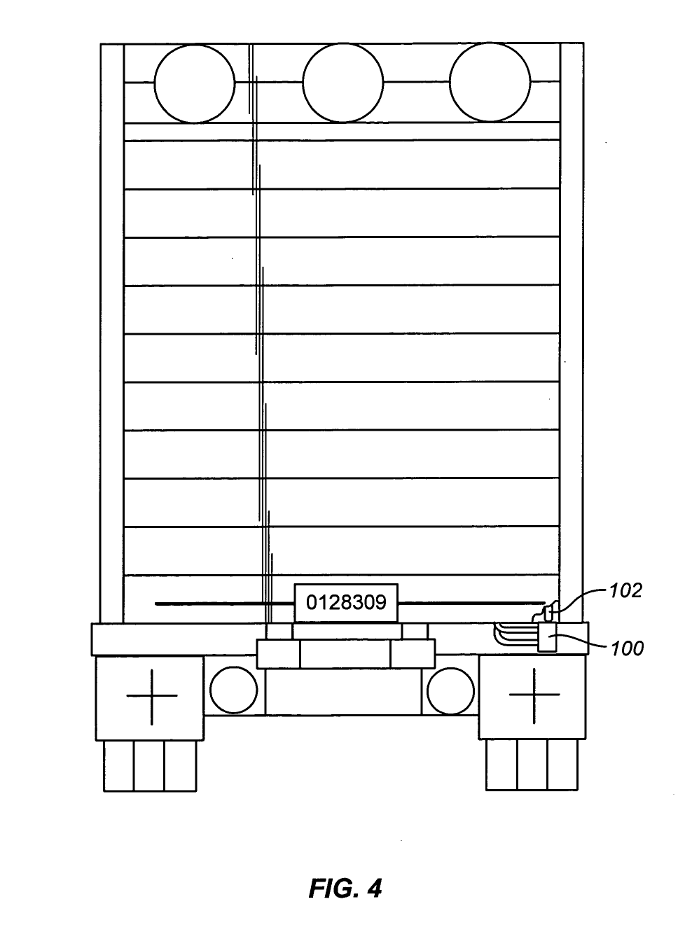

FIG. 4 shows an exemplary diagram showing the back of trailer which has been retrofitted with the door stop safety valve 100 in accordance with the embodiments of the present invention, with the trailer door down or closed. The valve 100 is connected with the bottom portion of the trailer frame using any suitable fastener. As is shown in FIG. 4, a plunger 102 that is connected with the bottom of the trailer door is dimensioned and configured to contact the valve spool when the door is fully closed to put the normally closed valve in its open position.

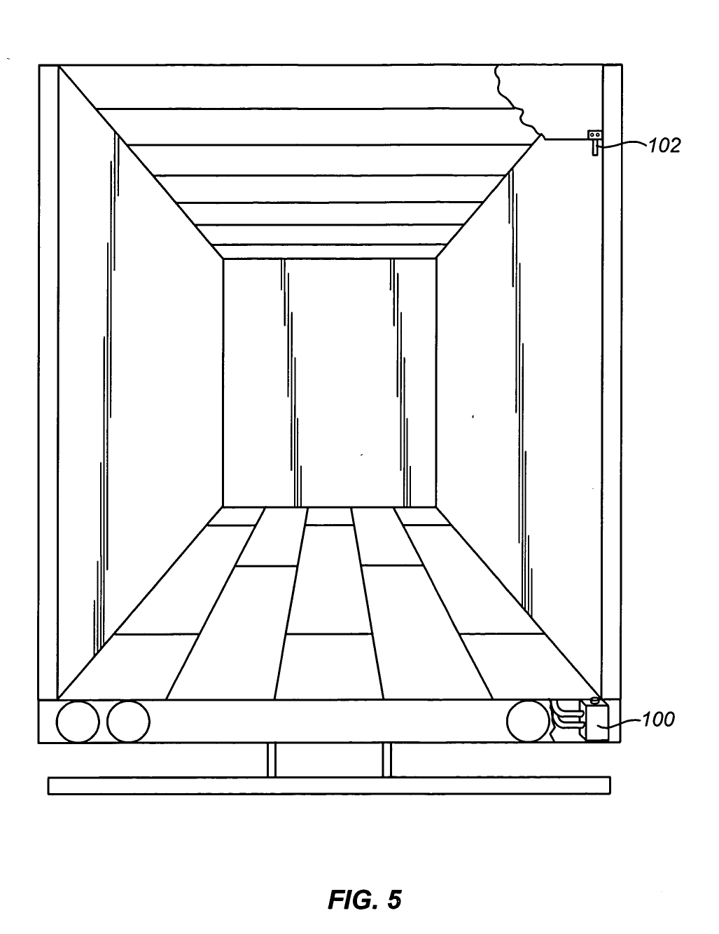

On the other hand, as shown in FIG. 5, when the trailer door is open, the door plunger 102 which is preferably mounted on the lower trailer door panel does not engage the spool of the door stop safety valve 100, thus leaving the normally closed valve in its normally closed position, thus not allowing air to flow through the service/release valve to thus prevent the release of the brakes. The plunger can be connected with the trailer panel using any suitable fastener.

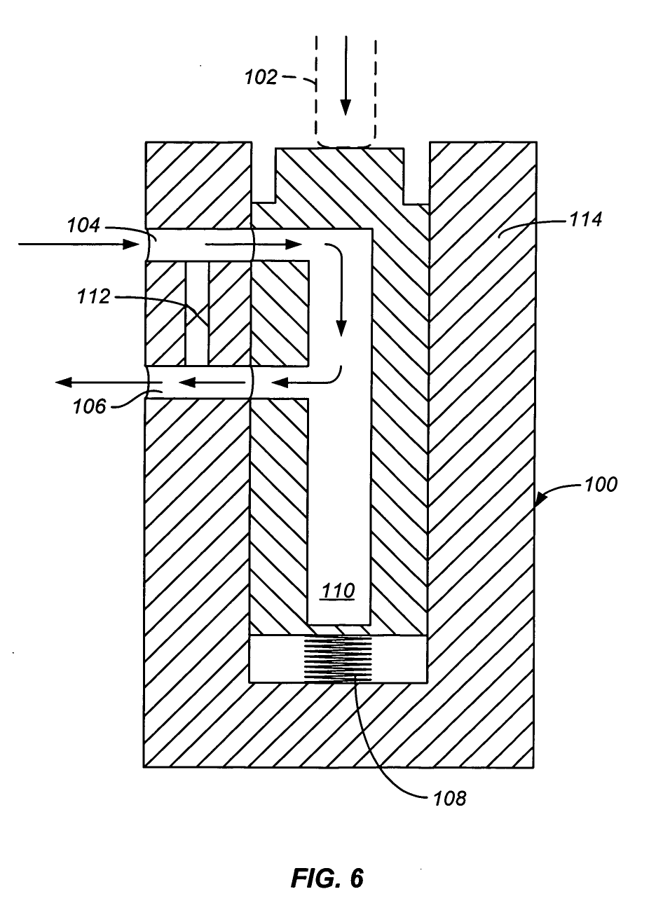

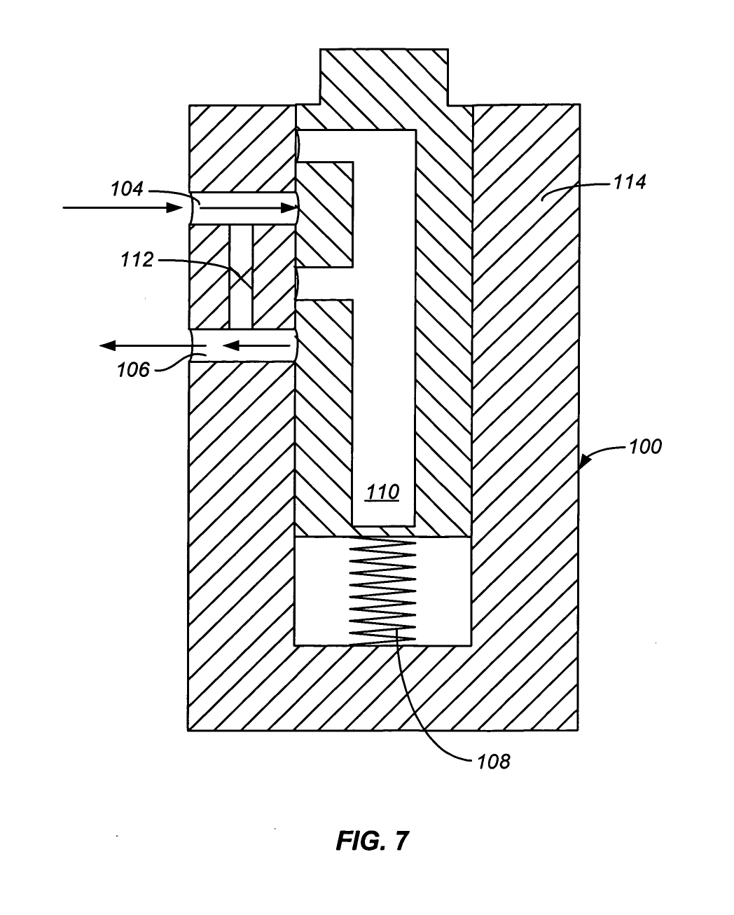

FIG. 6 shows a simplified cross-sectional view through the door stop safety valve 100 in accordance with the embodiments of the present invention, with the trailer door down or closed. And FIG. 7 shows a simplified cross-sectional view through the door stop safety valve 100 in accordance with the embodiments of the present invention, with the trailer door up or open. As shown in FIGS. 6-7, the valve 100 includes a body 114. The valve 100 is activated by the plunger 102 which is configured to push on a spring-biased spool 110. The valve body includes a first port 104 and a second port 106. The spool 110 is biased against the spring 108 and in combination with the plunger 102 can travel between its normally closed (FIG. 7) and its open position (FIG. 6). In addition, the two-position two-port spool valve 100 includes a manual bypass fluid path 112 configured for providing a fluid communication path between the first port and the second port, regardless of the position of the spool valve. A valve (e.g. manual) in line 112 can be used to open or close the bypass fluid path 112. Shown in FIG. 6, the trailer door is down and the plunger 102 is pushing on the spool 110 allowing air flow to the service/release valve, to allow the release of the brakes and the movement of the truck. As shown in FIG. 7, when the trailer door is up and/or the plunger 102 is not pushing against spool 100, the valve 100 is in its relaxed and normally closed state thus preventing air flow to the service/release valve, and preventing the release of the brakes and the movement of the truck. The valve and its parts can be made from any suitable materials such as aluminum, steel and other known materials that are suitable for such an air-pressure based system. It should be noted that the bypass valve and bypass fluid path 112 can be either incorporated with the valve 100 or can be separate from the valve. The bypass allows for the valve to be bypassed completely in case the door was damaged or when the trailer has to be moved with its door up. In either bypass arrangement the bypass path is configured so that the port that comes in to supply air to valve and the port going out of the valve have one common port to connect them together. In this bypass path between the two ports a shut off valve is located to control and allow air to bypass the truck door activated brake air-release, or close the bypass valve and thus allow the truck door activated brake release to function as described above.

As will be understood by those skilled in the art, other equivalent or alternative systems and methods for retrofitting a brake system with the novel door stop safety valve according to the embodiments of the present invention can be envisioned without departing from the essential characteristics thereof. For example, the plunger can be a flat piece that pushes against an extended spool portion. Accordingly, the foregoing disclosure is intended to be illustrative, but not limiting, of the scope of the invention which is set forth in the following claims.

What is claimed is:

1. A truck trailer door-activated air brake release lock system for use with spring-set air-release vehicle brakes, comprising:
a two-position two-port spool valve having a
first port configured for fluid communication with a supply of pressurized air,
a second port configured for fluid communication with the air release inlet port for a truck trailer brake;
a spring-biased spool located within the body of the two-position two-port spool valve, said spool being configured to travel between a first position and a second position,
wherein in said first position, said spool valve is in an open position allowing said first port and said second port to be in fluid communication, and
wherein in said second position, said spool valve is in a closed position preventing a fluid communication between said first port and said second port; and
a plunger configured for being coupled with a truck trailer door, said plunger dimensioned for engaging said spool, such that when the truck trailer door is closed, said plunger is in contact with and causes said spool valve to be in said first position, and when the truck trailer door is not fully closed, said spool valve is in said second position.

2. The air brake release lock system of claim 1 wherein said two-position two-port spool valve comprises a manual bypass fluid path configured for providing a fluid communication path between said first port and said second port, regardless of the position of said spool valve.

3. The air brake release lock system of claim 2 wherein said bypass fluid path comprises a normally-closed manual valve.

4. The air brake release lock system of claim 1 wherein said two-position two-port spool valve comprises a spring dimensioned to move said spool to said second position when said plunger is not sufficiently engaging said spool to maintain said spool in said first position.

5. The air brake release lock system of claim 4 wherein said two-position two-port spool valve comprises a spring dimensioned to move said spool to said second position when the trailer door is not fully closed.

6. The air brake release lock system of claim 1 wherein said two-position two-port spool valve is normally in said second position.
